(19) United States
(12) Patent Application Publication
(10) Pub. No.: US 2016/0261456 A1
(43) Pub. Date: Sep. 8, 2016

(54) CONTROLLER BASED PROTECTION METHOD AND APPARATUS FOR SOFTWARE DEFINED NETWORK

(71) Applicant: ELECTRONICS AND TELECOMMUNICATIONS RESEARCH INSTITUTE, Daejeon (KR)

(72) Inventor: Bin Yeong YOON, Daejeon (KR)

(73) Assignee: ELECTRONICS AND TELECOMMUNICATIONS RESEARCH INSTITUTE, Daejeon (KR)

(21) Appl. No.: 15/059,025

(22) Filed: Mar. 2, 2016

(30) Foreign Application Priority Data
Mar. 2, 2015 (KR) 10-2015-0029313
May 22, 2015 (KR) 10-2015-0071821

(51) Int. Cl. H04L 12/24; H04L 29/06; H04L 12/723

(52) U.S. Cl. CPC H04L 41/0654; H04L 45/50; H04L 69/16

(57) ABSTRACT

Provided is a method and an apparatus for protecting a software defined network (SDN), the apparatus including a controller configured to perform a protection switching on at least one working path in an SDN, and a processor configured to set a first event of performing the protection switching and set a protection path before the first event occurs.

### CROSS-REFERENCE TO RELATED APPLICATION

This application claims the priority benefit of Korean Patent Application No. 10-2015-0029313 filed on Mar. 2, 2015 and Korean Patent Application No. 10-2015-0071821 filed on May 22, 2015, in the Korean Intellectual Property Office, the disclosures of which are incorporated herein by reference.

### BACKGROUND

1. Field of the Invention

Embodiments relate to a field of network protection, and more particularly, to a software defined network (SDN) protection apparatus and method.

2. Description of the Related Art

In terms of network protection requirements, when an error of voice connection is corrected within 50 ms, an occurrence of the error may be unrecognizable to a person. Based on the example, 50 ms protection is provided for a network protection. The 50 ms protection has been suggested when overall network traffic is focused on voices. Recently, various application services including data, streaming, and video are provided and thus, a usage of the 50 ms protection is decreasing in practice.

Software defined network (SDN) technology has been developed to provide increased scalability, reliability, and agility when compared to typical networks. In such environment, there is desire for a controller based protection apparatus and method to allow an SDN to provide a high availability and a short delay time. Also, the controller based protection method may be applicable in various forms and increase a reliability of network.

### SUMMARY

According to an aspect, there is provided an apparatus for protecting a software defined network (SDN), the apparatus including a controller configured to perform a protection switching on at least one working path in an SDN, and a processor configured to set a first event of performing the protection switching and set a protection path before the first event occurs, wherein the processor is configured to set the protection path to be a new working path and perform the protection switching when the first event occurs.

According to another aspect, there is also provided a method of protecting an SDN using a network protection apparatus, the method including setting a protection switching method corresponding to each of at least one level network protection apparatus disposed in at least one working path connecting a customer virtual network and a physical network, and performing, by the at least one level network protection apparatus, the set protection switching method in a first working path of the at least one working path when a message associated with an operation error is received from the first working path.

The setting may include arranging each of the at least one level network protection apparatus in a predetermined level in the at least one working path to be in a multi-level structure. The setting may include setting an event occurring in the at least one working path to be the operation error. The setting may further include setting a protection path before the message is received. The performing may include performing a protection switching by setting the protection path to be a new working path in response to the receiving of the message.

The performing may further include performing the protection switching by determining a restoration path in the at least one working path and setting the restoring path to be the new working path in response to the receiving of the message. The performing may include determining one working path corresponding to a predetermined setting value among the at least one working path to be the restoration path.

The method may further include classifying the at least one working path into a sub-connection in the same domain and an interconnection connecting neighboring domains. The setting may include setting a first protection switching method corresponding to the sub-connection and a second protection switching method corresponding to the interconnection. The performing may include performing the protection switching based on the first protection switching method when a message associated with the operation error corresponding to the sub-connection is received and performing the protection switching based on the second protection switching method when a message associated with the operation error corresponding to the interconnection is received.

According to still another aspect, there is also provided a method of protecting an SDN, the method including setting a first event of performing a protection switching in at least one working path of an SDN, and setting a protection path for the at least one working path before the first event occurs. The method may further include performing the protection switching by setting the protection path to be a new working path when the first event occurs.

The method may further include setting a second event occurring in the at least one working path and determining a restoration path in the SDN when the second event occurs. The determining may include determining a first restoration path corresponding to a predetermined setting value among one or more restoration paths to be the at least one working path.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1A and 1B are block diagrams illustrating an example of a network protection apparatus according to an example embodiment;

FIG. 2 is a block diagram illustrating another example of a network protection apparatus according to an example embodiment;

FIGS. 3A and 3B are block diagrams illustrating a multi-level network protection apparatus according to an example embodiment;

FIG. 4 is a flowchart illustrating a software defined network (SDN) protection method according to an example embodiment;

FIG. 5 is a flowchart illustrating a method of protecting a network in a multi-domain according to an example embodiment; and

FIG. 6 is a flowchart illustrating a network protection method of a transmission network according to an example embodiment.

### DETAILED DESCRIPTION

Hereinafter, some example embodiments will be described in detail with reference to the accompanying drawings. It should be understood, however, that there is no intent to limit this disclosure to the particular example embodiments disclosed. Like numbers refer to like elements throughout the description of the figures.

Terminologies used herein are defined to appropriately describe the example embodiments of the present disclosure and thus may be changed depending on a user, the intent of an operator, or a custom. Accordingly, the terminologies must be defined based on the following overall description of this specification.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

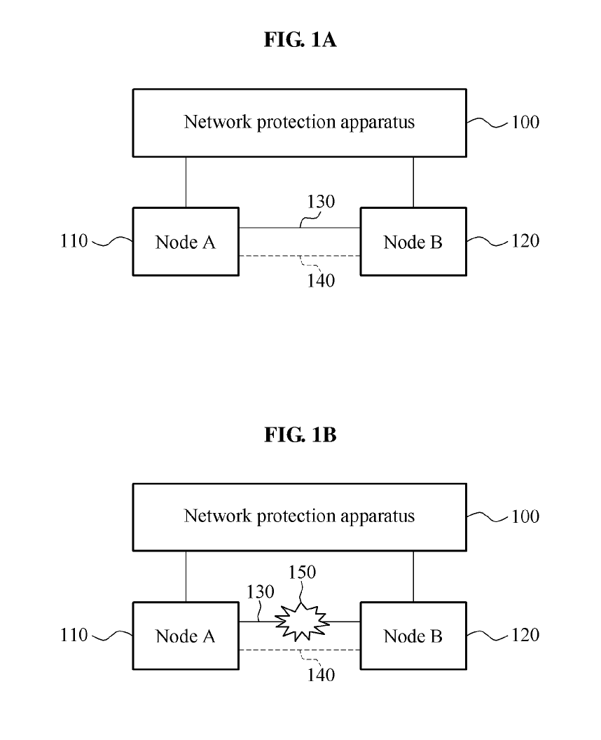

FIGS. 1A and 1B are block diagrams illustrating an example of a network protection apparatus according to an example embodiment. FIG. 1A illustrates a network protection apparatus 100, a node A 110, a node B 120, a working path 130, and a protection path 140. The network protection apparatus 100 may generate the working path 130 and the protection path 140 connecting the node A 110 and the node B 120. For example, the working path 130 and the protection path 140 may be generated on a data plane configuring a software defined network (SDN). The network protection apparatus 100 may generate the protection path 140 before a specific event corresponding to a path error occurs in the working path 130. Through this, an increased availability may be ensured to be provided to a network user.

FIG. 1B illustrates a specific event 150 occurring in the working path 130. The network protection apparatus 100 may set the specific event 150 to be the path error. For example, the specific event 150 may be one of a signal failure (SF), a manual switching (MS), and a forced switching (FS). The network protection apparatus 100 may perform a protection switching when the path error occurs in the working path 130. The network protection apparatus 100 may receive a message associated with the path error corresponding to the specific event 150 from the working path 130. The protection switching performed by the network protection apparatus 100 may be an operation of determining the protection path 140 to be a new working path.

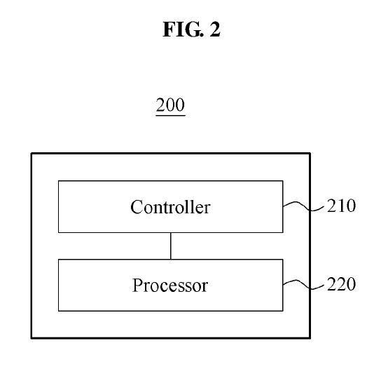

FIG. 2 is a block diagram illustrating another example of a network protection apparatus according to an example embodiment. A network protection apparatus 200 may include a controller 210 and a processor 220. The network protection apparatus 200 may set an event occurring in a working path to be a path error and protect a network by performing a protection switching when the path error occurs. The network may be, for example, an SDN.

The controller 210 may perform the protection switching for at least one working path in the SDN. For example, the protection switching may be performed by substituting a first working path in which the path error occurs with a preset protection path.

The processor 220 may set a first event for performing the protection switching. The first event may be, for example, an event that may occur in the first working path during a data transmitting and receiving process. Also, the processor 220 may set a protection path for performing the protection switching before the first occurs. The processor 220 may perform the protection switching by setting the protection path to be a new working path when the first event occurs. The processor 220 may set the protection path prior to an occurrence of the first event, thereby ensuring a high network availability for users.

In an example, the processor 220 may set a second event occurring in at least one working path. The processor 220 may determine a restoration path in the SDN when the second event occurs. For example, the processor 220 may determine one working path corresponding to a predetermined setting value to be the restoration path. The setting value may be input by a user through the network protection apparatus 200. In response to a request of the user, the setting value may be determined to designate a desired restoration path. As an example, the setting value may be a value determined to have a minimum time delay for establishing a connection of the at least one working path. In this example, the processor 220 may set an optimal working path to be the restoration path such that a network operator spends reduced costs.

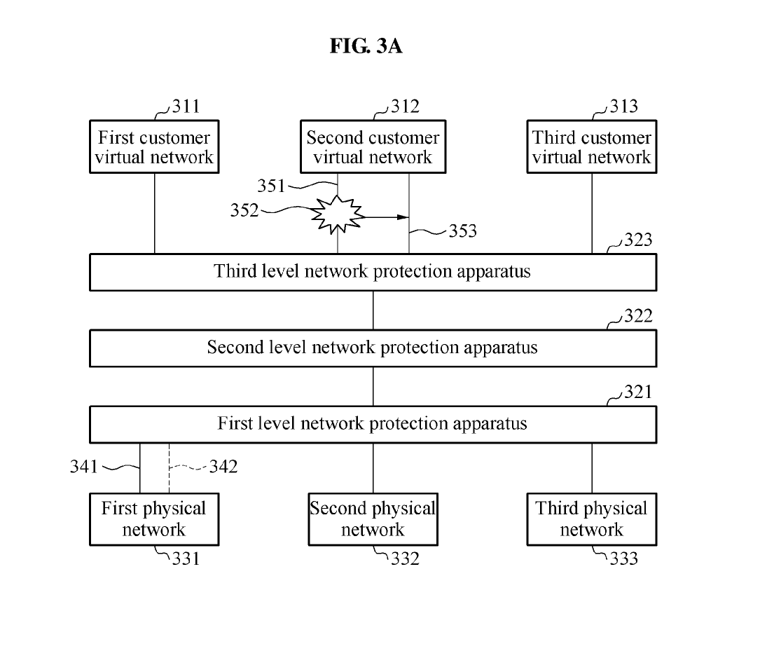

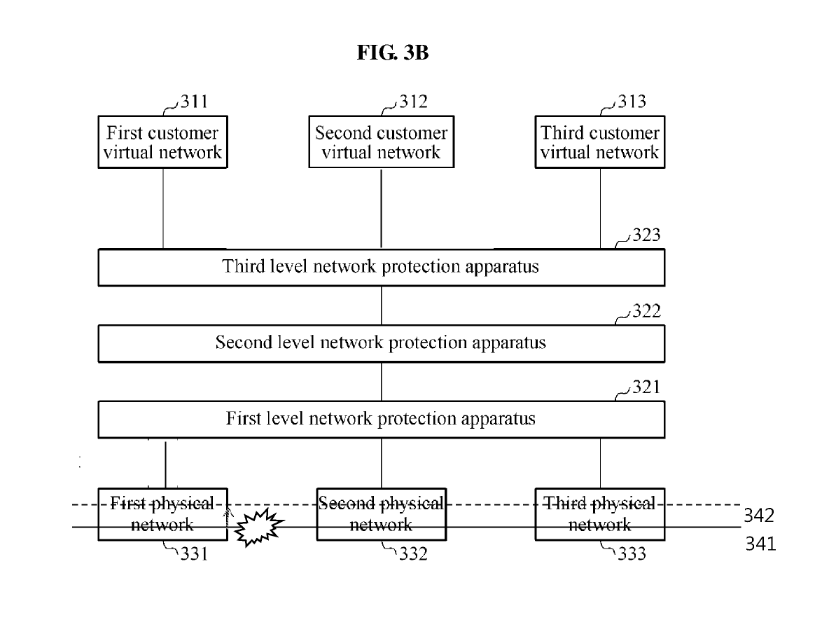

FIG. 3A is a block diagram illustrating a multi-level network protection apparatus according to an example embodiment. Referring to FIG. 3A, a plurality of customer nodes, for example, a first customer virtual network 311, a second customer virtual network 312, and a third customer virtual network 313 may be connected to a plurality of physical networks, for example, a first physical network 331, a second physical network 332, and a third physical network 333 through multi-level network protection apparatuses, for example, a first level network protection apparatus 321, a second level network protection apparatus 322, and a third level network protection apparatus 323. Although FIG. 3A illustrates three customer virtual networks, three level network protection apparatuses, and three physical networks as an example, it is obvious to those skilled in the art that the present disclosure is not limited to the example and is extensively applicable to an example in which at least one customer virtual network, at least one level network protection apparatus, and at least one physical network are provided. FIG. 3B is a block diagram illustrating another multi-level network protection apparatus according to an example embodiment.

Each of the plurality of customer virtual networks 311, 312, and 313 may be connected to one of the plurality of physical networks 331, 332, and 333, and request the multi-level network protection apparatuses 321, 322, and 323 to protect a connection path. For example, each of the plurality of customer virtual networks 311, 312, and 313 may include at least one virtual node.

To protect the connection path, the multi-level network protection apparatus may set a corresponding protection method for each of the level network protection apparatuses 321, 322, and 323. Also, the multi-level network protection apparatus may set the corresponding network protection method independently of the physical networks 331, 332, and 333 with which a connection is to be established finally. The network protection method may be, for example, one of a controller based protection method and a controller based restoration method. As an example, when the controller based protection method is set, the multi-level network protection apparatuses 321, 322, and 323 may provide a high connection possibility and a less time delay.

In an example, it is assumed that the first level network protection apparatus 321 selects the controller based network protection method to protect a network of a connection between the first customer virtual network 311 and the first physical network 331. The first level network protection apparatus 321 may set a plurality of events to be recognized as a path error in a current working path 341. Additionally, the first level network protection apparatus 321 may set a protection path 342 for performing a protection switching before one of the plurality of events occurs. Also, when the path error is found in the working path 341, the first level network protection apparatus 321 may perform the protection switching by setting the protection path 342 to be a new working path. The first level network protection apparatus 321 may perform a network protection by allowing the first customer virtual network 311 to user a preset protection path, for example, the protection path 342 for data transmission and reception in response to the path error.

In another example, it is assumed that the third level network protection apparatus 323 selects the controller based network restoration method to protect a network of a connection between the second customer virtual network 312 and the second physical network 332. When a path error 352 is found in a working path 351 being currently operated, the third level network protection apparatus 323 may perform a path computation for a path restoration. Based on a result of the path computation, the third level network protection apparatus 323 may set a new working path 353 to allow a network operation. The new working path 353 may be a path through which a path connection is available with a highest speed and lowest costs by applying a current network environment. Through this, the third level network protection apparatus 323 may perform a low cost network protection method.

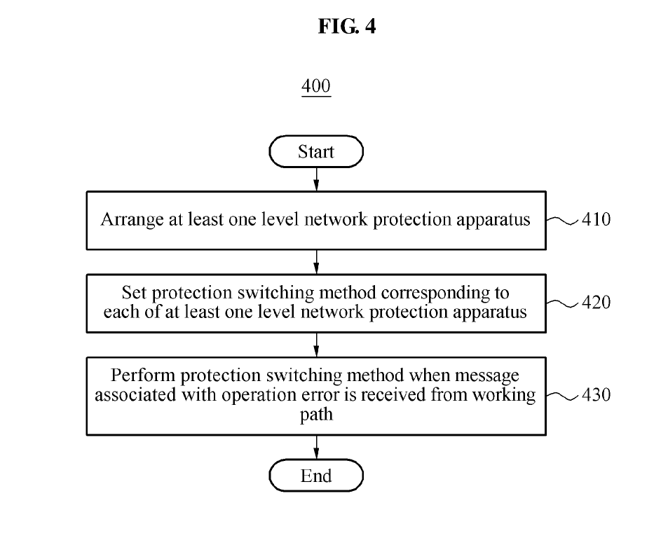

FIG. 4 is a flowchart illustrating an SDN protection method according to an example embodiment. An SDN protection method 400 includes operation 410 of arranging at least one level network protection apparatus, operation 420 of setting a protection switching method corresponding to the at least one level network protection apparatus, and operation 430 of performing the set protection switching method when a message associated with an operation error from a working path is received.

Operation 410 is an operation of arranging at least one level network protection apparatus in at least one working path of an SDN. For example, the at least one working path may be a path connecting between at least one customer virtual network and at least one physical network. Also, in operation 410, the at least one level network protection apparatus may be arranged in a predetermined level in the at least one working path to be in a multi-level structure.

Operation 420 is an operation of setting a protection switching method corresponding to each of the at least one level network protection apparatus. For example, the protection switching method may be one of a controller based network protection method and a controller based network restoration method. Operation 420 may further include an operation of setting an event that may occur in the at least one working path to be an operation error. The event may be, for example, one of a signal failure (SF), a manual switching (MS), and a forced switching (FS). In an example, when the controller based network protection method is set, operation 420 may further include an operation of setting a protection path before a message associated with the operation error is received.

Operation 430 is an operation of performing the protection switching method when the message associated with the operation error is received from a working path. As an example, when the message associated with the operation error is received from a first working path of the at least one working path, at least one level network protection apparatus of the first working path may perform the protection switching method. In an example, when the controller based restoration method is set in operation 420, operation 430 may include an operation of performing the protection switching by determining a restoration path from the at least one working path and setting the determined restoration path to be a new working path in response to the receiving of the message associated with the operation error. For example, in operation 430, from the at least one working path, one working path having a minimum time delay for a connection may be determined to be the restoration path. In another example, when the controller based network protection method is set in operation 420, operation 430 may be an operation of performing the protection switching by setting the protection path to be the new working path in response to the receiving of the message associated with the operation error.

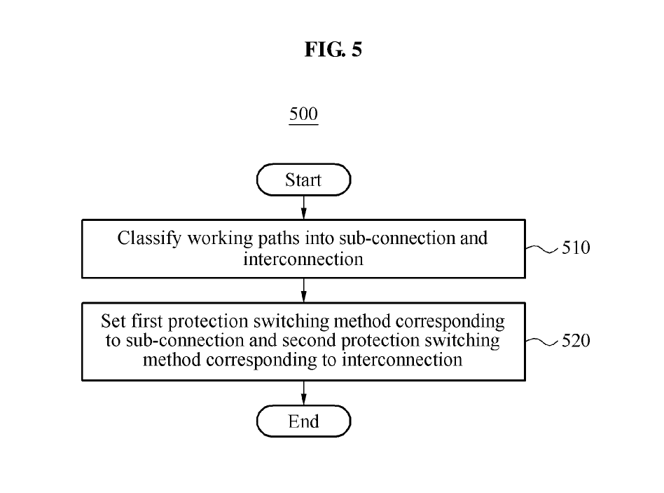

FIG. 5 is a flowchart illustrating a method of protecting a network in a multi-domain according to an example embodiment. A method 500 of protecting a network in a multi-domain may include operation 510 of classifying working paths into a sub-connection and an interconnection and operation 520 of setting a first protection switching method corresponding to the sub-connection and a second protection switching method corresponding to the interconnection.

Operation 510 may be an operation of classifying at least one working path of an SDN into a sub-connection and an interconnection. As an example, the sub-connection may be a working path included in the same domain. As another example, the interconnection may be a working path connecting neighboring different domains. In the SDN, a customer virtual network may request a network protection to be connected to a physical network. Also, a multi-domain may be a network including a working path connecting different domains of the SDN. The multi-domain may include nodes using different network policies, different network device vendors, and different protocols. Due to a presence of the node, it is difficult to implement the same network protection method in an end-to-end connection. Thus, in example embodiments, the at least one working path may be classified into the sub-connection and the interconnection such that different network protection methods are applied.

Operation 520 may be an operation of setting a first protection switching method corresponding to the sub-connection and a second protection switching method corresponding to the interconnection. In operation 520, one of a controller based network protection method and a controller based restoration method may be selected for the first protection switching method and the second protection switching method based on a network environment. As the foregoing, in this disclosure, a differing network protection method may be set based on a difference in network policy, a difference in network device vendor, and a protocol of working paths and thus, the issue of a general method of protecting a network in a multi-domain may be solved.

Operation 520 may further include an operation of performing a protection switching based on the first protection switching method when a message associated with an operation error corresponding to the sub-connection is received and performing the protection switching based on the second protection switching method when a message associated with an operation error corresponding to the interconnection is received.

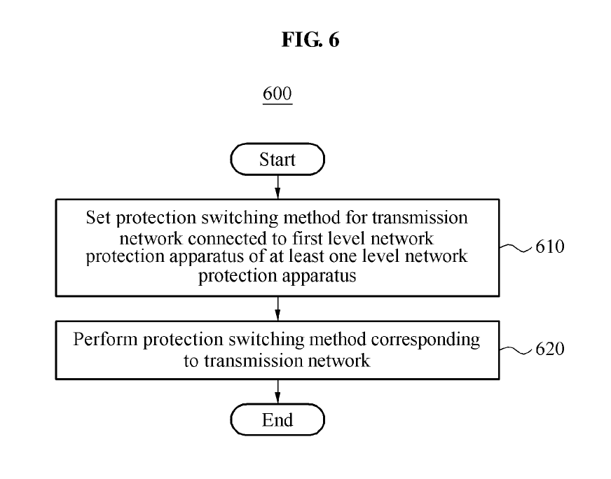

FIG. 6 is a flowchart illustrating a network protection method of a transmission network according to an example embodiment. A network protection method 600 of a transmission network may include operation 610 of setting a protection switching method for a transmission network connected to a first level network protection apparatus of at least one level network protection apparatus, and operation 620 of performing the protection switching method corresponding to the transmission network. The network protection method 600 may provide a higher availability to a layer L3 for a router. Also, the network protection method 600 may set a corresponding protection method for each transmission network through which an Internet protocol (IP) packet, thereby ensuring a high availability. In general, a multi-protocol may include multiple domains and use a different protocol for each of the domains. In this example, a domain using different protocols in one working path may be present. Thus, intervals using the same protocol may need to be separated. The aforementioned example may be based on a case in which paths using different protocols have different operations, administration and maintenance (OAM) protocols and thus, error detection may be impossible. For this reason, the following operations are provided to solve the issue as an example.

Operation 610 is an operation of setting a protection switching method for a transmission network connected to a first level network protection apparatus of at least one level network apparatus included in an SDN. As an example, the transmission network may be an IP over Ethernet network. As another example, the transmission network may also be an IP over MPLS-TE network. As still another example, the transmission network may be an IP over WDM network. Although the aforementioned types of transmission network are described as an example, the present disclosure is not limited thereto. Thus, the transmission network may also be one of various types of protocols used for data transmission and reception. Also, the protection switching method may be one of a controller based network protection method and a controller based network restoration method.

Operation 620 may be an operation of performing the protection switching method corresponding to the transmission network. For example, in operation 620, the protection switching method corresponding to the transmission network may be performed when a message associated with an operation error is received from the at least one working path used to establish a connection of the transmission network. The descriptions of the aforementioned apparatus are also applicable to here and thus, related descriptions with respect to the controller based network protection method and the controller based network restoration method will be omitted.

The above-described embodiments of the present disclosure may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tapes; optical media such as CD ROMs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present disclosure, or vice versa.

Although a few embodiments of the present disclosure have been shown and described, the present disclosure is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An apparatus for protecting a software defined network (SDN), the apparatus comprising:
a controller configured to perform a protection switching on at least one working path in an SDN; and
a processor configured to set a first event of performing the protection switching and set a protection path before the first event occurs.

2. The apparatus of claim 1, wherein the processor is configured to set the protection path to be a new working path and perform the protection switching when the first event occurs.

3. The apparatus of claim 1, wherein the processor is configured to set a second event occurring in the at least one working path and determine a restoration path in the SDN when the second event occurs.

4. The apparatus of claim 3, wherein the processor is configured to determine one restoring path corresponding to a predetermined setting value among one or more restoring paths to be the at least one working path.

5. A method of protecting a software defined network (SDN) using a network protection apparatus, the method comprising:
setting a protection switching method corresponding to each of at least one level network protection apparatus disposed in at least one working path connecting a customer virtual network and a physical network; and
performing, by the at least one level network protection apparatus, the set protection switching method in a first working path of the at least one working path when a message associated with an operation error is received from the first working path.

6. The method of claim 5, wherein the setting comprises arranging each of the at least one level network protection apparatus in a predetermined level in the at least one working path to be in a multi-level structure.

7. The method of claim 5, wherein the setting comprises setting an event occurring in the at least one working path to be the operation error.

8. The method of claim 7, wherein the setting further comprises setting a protection path before the message is received.

9. The method of claim 8, wherein the performing comprises performing a protection switching by setting the protection path to be a new working path in response to the receiving of the message.

10. The method of claim 8, wherein the performing further comprises performing the protection switching by determining a restoration path in the at least one working path and setting the restoring path to be the new working path in response to the receiving of the message.

11. The method of claim 10, wherein the performing comprises determining one restoration path corresponding to a predetermined setting value among one or more restoration paths to be the at least one working path.

12. The method of claim 5, further comprising:
classifying the at least one working path into a sub-connection in the same domain and an interconnection connecting neighboring domains.

13. The method of claim 12, wherein the setting comprises setting a first protection switching method corresponding to the sub-connection and a second protection switching method corresponding to the interconnection.

14. The method of claim 13, wherein the performing comprises performing the protection switching based on the first protection switching method when a message associated with the operation error corresponding to the sub-connection is received and performing the protection switching based on the second protection switching method when a message associated with the operation error corresponding to the interconnection is received.

15. The method of claim 5, wherein the setting comprises setting a protection switching method for a transmission network connected to a first level network protection apparatus of the at least one level network protection apparatus.

16. The method of claim 15, wherein the transmission network is one of an Internet protocol (IP) over Ethernet network, an IP over multi-protocol label switching-traffic engineering (MPLS-TE) network, and an IP over wavelength division multiplexing (WDM) network.

17. A method of protecting a software defined network (SDN), the method comprising:
setting a first event of performing a protection switching in at least one working path of an SDN; and
setting a protection path for the at least one working path before the first event occurs.

18. The method of claim 17, further comprising:
performing the protection switching by setting the protection path to be a new working path when the first event occurs.

19. The method of claim 17, further comprising:
setting a second event occurring in the at least one working path; and
determining a restoration path in the SDN when the second event occurs.

20. The method of claim 19, wherein the determining comprises determining a first restoration path corresponding to a predetermined setting value among one or more restoration paths to be the at least one working path.
